(19) United States
(12) Patent Application Publication
(10) Pub. No.: US 2025/0188303 A1
(43) Pub. Date: Jun. 12, 2025

(54) INK SET

(71) Applicants: Hikaru Ishii, Kanagawa (JP); Yuta Nakamura, Tokyo (JP); Shunsuke Horie, Kanagawa (JP)

(72) Inventors: Hikaru Ishii, Kanagawa (JP); Yuta Nakamura, Tokyo (JP); Shunsuke Horie, Kanagawa (JP)

(73) Assignee: Ricoh Company, Ltd., Tokyo (JP)

(21) Appl. No.: 18/964,883

(22) Filed: Dec. 2, 2024

(30) Foreign Application Priority Data
Dec. 8, 2023 (JP) 2023-207427
Aug. 6, 2024 (JP) 2024-129876

(51) Int. Cl. C09D 11/54; C09D 11/322; C09D 11/38; C09D 11/40

(52) U.S. Cl. CPC C09D 11/54; C09D 11/322; C09D 11/38; C09D 11/40

(57) ABSTRACT

An ink set contains: a pre-processing fluid that contains water, an aggregating agent, and a first organic solvent; a pigment ink that contains: a second organic solvent that contains water, a coloring material, and a glycolether compound; a polyoxyethylene alkyl ether; and a resin, wherein the content of the aggregating agent in the pre-processing fluid is 1.0 to 20.0 percent by mass, the content of the glycolether compound in the pigment ink is 10.0 to 20.0 percent by mass, the content of the polyoxyethylene alkyl ether therein is 1.0 to 5.0 percent by mass, the following Relationship 0.25≤P/R≤3.0 is satisfied, where P represents the content of the coloring material in the pigment ink and R represents the content of the resin therein, and the difference in the mixed SP value between the first and the second organic solvent is at least 2.0 (cal/cm³)^{0.5}.

### CROSS-REFERENCE TO RELATED APPLICATIONS

This patent application is based on and claims priority pursuant to 35 U.S.C. § 119 to Japanese Patent Application Nos. 2023-207427 and 2024-129876, filed on Dec. 8, 2023 and Aug. 6, 2024, respectively, in the Japan Patent Office, the entire disclosures of which are hereby incorporated by reference herein.

### BACKGROUND

### Technical Field

The present disclosure is related to an ink set.

### Description of the Related Art

In recent years, even in the fields of commercial and industrial printing, where analog printing methods such as offset printing and flexographic printing have been dominant, there is an increasing demand for inkjet printers as digital printing, which does not require plates and allows for printing various designs in small quantities.

High speed printing is inevitable in industrial settings because printing in industrial settings is required to be productive in comparison with consumer printing. To accommodate this high speed printing, increasing the pinning speed of ink on a recording medium is necessary. The pinning speed means the time from ink diffusion to fixing on a recording medium.

The combination of aqueous ink with a recording medium having a coated layer for offset printing paper faces a typical problem of beading which would occur on offset printing paper due to its low absorbency, resulting in reduced image quality. Additionally, sequentially overlapped layers of color inks with different hues bleeds at the color boundaries (hereafter referred to as bleeding), leading to a significant decline in image quality.

### SUMMARY

According to the present disclosure, an ink set is provided which contains a pre-processing fluid containing water, an aggregating agent, and a first organic solvent, a pigment ink containing a second organic solvent containing water, a coloring material, and a glycolether compound, a polyoxyethylene alkyl ether, and a resin, wherein the content of the aggregating agent in the pre-processing fluid is between 1.0 percent by mass and 20.0 percent by mass, the content of the glycolether compound in the pigment ink is between 10.0 percent by mass and 20.0 percent by mass, the content of the polyoxyethylene alkyl ether in the pigment ink is between 1.0 percent by mass and 5.0 percent by mass, the following Relationship is satisfied: 0.25≤P/R≤3.0, where P represents the content of the coloring material in the pigment ink and R represents the content of the resin in the pigment ink, and the difference in the mixed SP value between the first organic solvent and the second organic solvent is at least 2.0 (cal/cm³)^{0.5}.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a perspective view of an example of a printing device using the ink in the present disclosure; and

FIG. 2 is a diagram illustrating a perspective view of a tank storing the ink in the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, an ink set is provided which has excellent pinning speed and discharging stability while minimizing beading and bleeding.

A method has been proposed in Japanese Unexamined Patent Application Publication No. 2012-052027 in which a pre-processing fluid is applied to promote the aggregation of ink pigments and prevent bleeding thereof.

The method disclosed in Japanese Unexamined Patent Application Publication No. 2012-052027 mentioned above indeed improves the image quality regarding beading and bleeding by using a multivalent metal salt in the pre-processing fluid for inkjet recording, but the pinning speed between the ink's diffusion and fixing on the recording medium mentioned above has not been examined in the context of high speed printing.

That is, such a method as disclosed in Japanese Unexamined Patent Application Publication No. 2012-052027 mentioned above improves the image quality with respect to beading and bleeding by using a multivalent metal salt; however, it has not examined the pinning speed—from ink diffusion to fixing on the offset recording medium—in the context of high-speed printing. In fact, the pinning speed was measured using typical ink formulations and did not meet the required level for high speed printing at 40 kHz.

Consequently, in attempts to improve the pinning speed, the amounts of penetrants and surfactants contained in the ink mentioned above were adjusted, but the speed still failed to meet the required level.

After intensive research, the present inventors of the present invention have found that an ink set containing a pre-processing fluid and a pigment ink configured with the following compositions achieves excellent pinning speed and discharging stability for high speed printing while minimizing beading and bleeding.

### Pre-processing Fluid

The pre-processing fluid contains water, an aggregating agent, and an organic solvent (first organic solvent), with a content of the aggregating agent in the pre-processing fluid set to between 1.0 percent by mass and 20.0 percent by mass.

### Pigment Ink

The pigment ink contains an organic solvent (second organic solvent) that contains at least water, a coloring material, and a glycol ether compound, polyoxyethylene alkyl ether, and a resin.

In the pigment ink, the content of polyoxyethylene alkyl ether is set to between 1.0 percent by mass and 5.0 percent by mass, and the content of the glycol ether compound is set to between 10.0 percent by mass and 20.0 percent by mass.

The ratio P/R is set to between 0.25 and 3.0, where P represents the content of the coloring material in the pigment ink and R represents the content of the resin.

The mixed SP value of the organic solvents contained in the pigment ink differs from that in the pre-processing fluid, with a difference of at least 2.0 (cal/cm³)^{0.5}.

Hereinafter, the term “ink” may be also used to refer to “pigment ink.”

Applying the pre-processing fluid to a substrate prior to the ink application reduces smearing and color unevenness caused by mixing of ink droplets and minimizes beading and bleeding in the ink layer on the pre-processing fluid on offset recording paper. This effect is attributable to the aggregating agent, such as a multivalent metal salt, contained in the processing fluid. Among aggregating agents, multivalent metal salts are preferred because they have a low molecular weight, allowing easy movement of cationic components, and they instantly dissolve in water to release cationic components that aggregate solid components. Therefore, when ink is applied to a substrate coated with this processing fluid, the cationic components immediately disperse throughout the entire layer, inducing aggregation of the pigment.

Furthermore, adding an organic solvent containing at least a glycol ether compound to the ink, along with polyoxyethylene alkyl ether, increases penetration speed and wetting speed, thereby improving the pinning speed. At this time, the difference in the mixed SP value between the organic solvents in the ink and those in the pre-processing fluid reduces compatibility, which further enhances the pinning speed.

It is preferable that the mixed SP value of the organic solvents contained in the pigment ink be between 10.0 (cal/cm³)^{0.5} and 12.0 (cal/cm³)^{0.5}, while that of the organic solvents in the pre-processing fluid be between 13.0 (cal/cm³)^{0.5} and 15.0 (cal/cm³)^{0.5}.

Additionally, the penetration and wetting speeds can be further increased by adjusting the content ratio of the coloring material to the resin in the pigment ink, improving the pinning speed.

The definition of the “mixed SP value” will be described later.

The present disclosure is detailed below.

### Ink

The ink in the ink set of the present disclosure contains water, a coloring material, an organic solvent, a surfactant, and a resin, and may also contain other optional components. The term “ink” in the present disclosure refers to those formulations that use a colored material other than white as the coloring material.

Below, the organic solvent used in the ink and the pre-processing fluid and the coloring material, surfactant, resin, and other components used in the ink in the present disclosure will be described.

### Organic Solvent

There is no specific limitation to the organic solvent for use in the present disclosure. For example, a water-soluble organic solvent can be used. It includes, but is not limited to, polyhydric alcohols, ethers such as polyhydric alcohol alkylethers and polyhydric alcohol arylethers, nitrogen-containing heterocyclic compounds, amides, amines, and sulfur-containing compounds.

Specific examples include, but are not limited to, polyhydric alcohols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutyl ether, diethylene glycol monomethylether, diethylene glycol monoethylether, diethylene glycol monobutyl ether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propionamide, and 3-butoxy-N,N-dimethyl propionamide; amines such as monoethanolamine, diethanolamine, and triethylamine; sulfur-containing compounds such as dimethyl sulfoxide, sulfolane, and thiodiethanol; propylene carbonate, and ethylene carbonate.

It is preferable to use an organic solvent with a boiling point of at most 250 degrees Celsius, which serves as a humectant that dries quickly.

The organic solvent preferably includes a polyol compound with 8 or more carbon atoms and a glycol ether compound. In the present disclosure, it contains at least a glycol ether compound.

Specific examples of the polyol compounds containing 8 or more carbon atoms include, but are not limited to, 2-ethyl-1,3-hexanediol and 2,2,4-trimethyl-1,3-pentanediol.

Specific examples of the glycolether compound include, but are not limited to, polyhydric alcohol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether and polyhydric alcohol arylethers such as ethylene glycol monophenylether and ethylene glycol monobenzylether.

A polyol compound having eight or more carbon atoms and a glycol ether compound enhance permeability of ink for paper used as a recording medium.

“SP value” refers to the Solution Parameter and is generally used as an index for affinity and solubility of materials, such as a solvent, a resin, and a pigment dissolved or dispersed in water or a solvent for use.

The SP value can be obtained by various ways such as measuring by experiments, calculating by measuring physical properties such as immersion heat, or calculating from molecular structures. In the present disclosure, the SP value is obtained by the calculation method based on the molecule structure proposed by Fedors.

This method has the advantages that the SP value can be calculated for an available molecule structure and that the difference between the SP value calculated and the SP value measured in an experiment is slight.

In the present disclosure, according to the Method of Fedors, the SP value calculated from a molecular structure is used and represented in (cal/cm³)^{0.5}.

SP values can be calculated according to Fedors method disclosed in R. F. Fedors: Polym. Eng. Sci., 14[2], 147-154.

### Definition of Mixed SP Value

The mixed SP value of a liquid mixture of the organic solvents contained in the pre-processing fluid can be calculated according to the following Relationship 1 based on the molar fractions of the organic solvents contained in the pre-processing fluid. The mixed SP value (cal/cm³)^{0.5} of the liquid mixture of the organic solvents in the pre-processing fluid=[SP value of organic solvent A×molar fraction of organic solvent A]+[SP value of organic solvent B×molar fraction of organic solvent B]+ . . . . Relationship 1

Specific examples of the organic solvent include, but are not limited to, 3-ethyl-3-oxetane methanol (SP value of 11.31 (cal/cm³)^{0.5}), 3-methyl-3-oxetane methanol (SP value of 11.79 (cal/cm³)^{0.5}), β-methoxy-N,N-dimethyl propionamide (3-methoxy-N,N-dimethyl propionamide)(SP value of 9.19 (cal/cm³)^{0.5}), β-butoxy-N,N-dimethyl propionamide (3-buthoxy-N,N-dimethyl propionamide)(SP value of 10.27 (cal/cm³)^{0.5}), 1,2-hexanediol (SP value of 12.59 (cal/cm³)^{0.5}), 2-ethyl-1,3-hexanediol (SP value of 11.72 (cal/cm³)^{0.5}), 2,2,4-trimethyl-1,3-pentanediol (SP value of 10.8 (cal/cm³)^{0.5}), diethylene glycol monoethyl ether (SP value of 10.94 (cal/cm³)^{0.5}), 3-methoxy-1-butanol (SP value of 9.64 (cal/cm³)^{0.5}), 3-methoxy-3-methyl-1-butanol (SP value of 10.92 (cal/cm³)^{0.5}), 3-methyl-1,5-pentanediol (SP value of 11.8 (cal/cm³)^{0.5}), methylpropylene triglycol (SP value of 9.43 (cal/cm³)^{0.5}), diethylene glycol mono-n-butyhlether (SP value of 10.7 (cal/cm³)^{0.5}), diethylene glycol monomethyl ether (SP value of 11.23 (cal/cm³)^{0.5}), triethylene glycol monomethylether (SP value of 10.12 (cal/cm³)^{0.5}), propylene glycol monopropyl ether (SP value of 9.82 (cal/cm³)^{0.5}), propylene glycol monomethyl ether (SP value of 10.19 (cal/cm³)^{0.5}), propylene glycol monobutyl ether (SP value of 9.69 (cal/cm³)^{0.5}), 3-methoxy-1-butanol (SP value of 10.65 (cal/cm³)^{0.5}), 3-methoxy-1-propanol (SP value of 10.41 (cal/cm³)^{0.5}), dipropylene glycol monomethyl ether (SP value of 9.84 (cal/cm³)^{0.5}), and 3-methyl-1,5-pentanediol (SP value of 11.8 (cal/cm³)^{0.5}).

It is preferable to use an organic solvent with an SP value of from 8.0 to 20.0 (cal/cm³)^{0.5}.

These can be used alone or in combination.

There are no limitations on the content of the organic solvent with an SP value within the above range, and it can be appropriately set according to a particular application. However, in terms of discharging stability, a content of 20.0 to 40.0 percent by mass to the total amount of ink is preferred.

### Water

The proportion of water in the ink is not particularly limited and can be suitably selected to suit to a particular application. It is preferably from 10 to 90 percent by mass and more preferably from 20 to 60 percent by mass to quickly dry the ink and stably discharge it.

### Coloring Material

The coloring material has no particular limitation and includes such materials as a pigment and a dye.

The pigment includes an inorganic pigment and organic pigment. These can be used alone or in combination. Mixed crystal can also be used as the coloring material.

Examples of the pigments include, but are not limited to, black pigments, yellow pigments, magenta pigments, cyan pigments, white pigments, green pigments, orange pigments, and gloss or metallic pigments of gold, silver, and others.

Carbon black available from known methods such as contact methods, furnace methods, and thermal methods can be used as the inorganic pigment in addition to titanium oxide, iron oxide, calcium carbonate, barium sulfate, aluminum hydroxide, barium yellow, cadmium red, and chrome yellow.

Specific examples of the organic pigments include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black. Of these pigments, pigments with high affinity with solvents are preferable. Hollow resin particles and hollow inorganic particles can also be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51, C.I. Pigment Red 1, 2, 3, 5, 17, 22, 23, 31, 38, 48:2, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63, C.I. Pigment Green 1, 4, 7, 8, 10, 17, 18, and 36.

The dye is not particularly limited and includes, for example, acidic dyes, direct dyes, reactive dyes, basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material in ink is preferably from 0.1 to 15 percent by mass and more preferably from 1 to 10 percent by mass to enhance the image density, fixability, and discharging stability.

Pigment dispersion ink is obtained by, for example, preparing a self-dispersible pigment by introducing a hydrophilic functional group into a pigment, coating the surface of a pigment with a resin followed by dispersion, or using a dispersant for dispersing a pigment.

One such method of preparing a self-dispersible pigment by introducing a hydrophilic functional group into a pigment is to add a functional group such as a sulfone group and carboxyl group to a pigment (e.g., carbon) to disperse the pigment in water.

One such method of dispersing a pigment by coating the surface of the pigment with resin is to encapsulate pigment particles in microcapsules for dispersion in water. This microencapsulated pigment is also referred to as a resin-coated pigment. The resin-coated pigment particles in ink are not necessarily entirely coated with resin.

Pigment particles not partially or wholly covered with resin may be dispersed in ink unless such particles have an adverse impact.

One such method of using a dispersant for dispersing a pigment is to use a known dispersant of a small or large molecular weight, typically a surfactant.

As the dispersant, an anionic surfactant, a cationic surfactant, a nonionic surfactant, an amphoteric surfactant, or others can be selected depending on a pigment.

Also, a nonionic surfactant, RT-100, available from TAKEMOTO OIL & FAT CO., LTD. and a formalin condensate of naphthalene sodium sulfonate are suitable as the dispersant.

Those can be used alone or in combination.

### Pigment Dispersion

Ink can be obtained by mixing a pigment with materials such as water and an organic solvent. It is also possible to mix a pigment with water, a dispersant, and other substances to prepare a pigment dispersion and thereafter mix the pigment dispersion with materials such as water and an organic solvent to manufacture ink.

The particle size of this pigment dispersion is adjusted by mixing or dispersing with water, a pigment, a pigment dispersant, and other optional components. It is good to use a dispersing device for dispersion.

The particle diameter of the pigment in the pigment dispersion has no particular limit. For example, the maximum frequency is preferably from 20 to 500 nm and more preferably from 20 to 150 nm in the maximum number conversion to improve dispersion stability of the pigment and ameliorate discharging stability and the image quality such as image density. The particle diameter of a pigment can be analyzed using a particle size analyzer (Nanotrac Wave-UT151, available from MicrotracBEL Corp).

The proportion of the pigment in the pigment dispersion is not particularly limited and can be suitably selected to suit a particular application. It is preferably from 0.1 to 50 percent by mass and more preferably from 0.1 to 30 percent by mass to achieve good discharging stability and high image density.

It is preferable that the pigment dispersion be filtered with an instrument such as filter and a centrifuge to remove coarse particles followed by deaerating.

### Resin

The type of the resin contained in ink has no particular limit and can be suitably selected to suit to a particular application. It includes, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins.

Resin particles made of such resins can be also used. It is possible to obtain an ink by mixing a resin emulsion in which such resin particles are dispersed in water as a dispersion medium with materials such as a coloring material and an organic solvent. The resin particle can be synthesized or procured. These resins can be used alone or two or more types of the resin particles.

It is preferable that the resin contained in the pigment ink have a glass transition temperature Tg of at least 30 degrees Celsius. Furthermore, it is more preferable to use both a resin with a glass transition temperature of at least 30 degrees Celsius and a resin with a glass transition temperature lower than 0 degrees Celsius. A content of the resin in the range of 4.0 percent by mass to 15.0 percent by mass, it exhibits excellent drying properties.

Hereafter, the glass transition temperature may be referred to as Tg.

The type of the resin contained in ink has no particular limit and can be suitably selected to suit to a particular application. It includes, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins.

Resin particles made of such resins can be also used. It is possible to obtain ink by mixing a resin emulsion in which such resin particulate is dispersed in water as a dispersion medium with materials such as an organic solvent. The resin particle can be synthesized or procured.

Specific examples include products from the DAOTAN series by Daicel-Olnex, such as TW1225, VTW1265, VTW1686, VTW6450, VTW6460, VTW6462, VTW6463, and TW6464.

The volume average particle diameter of the resin particle is not particularly limited and can be suitably selected to suit to a particular application. The volume average particle diameter is preferably from 10 to 1,000 nm, more preferably from 10 to 200 nm, and particularly preferably from 10 to 100 nm to achieve good fixability and image robustness.

The volume average particle diameter can be measured by using a device such as a particle size analyzer (Nanotrac Wave-UT151, available from MicrotracBEL Corp.).

The proportion of the resin is not particularly limited and can be suitably selected to suit to a particular application. It is preferably from 1 to 30 percent by mass and more preferably from 5 to 20 percent by mass to the entire ink to ensure fixability and storage stability of the ink.

The particle diameter of the solid portion in the ink has no particular limit and can be suitably selected to suit to a particular application. For example, the maximum frequency in the maximum number conversion is preferably from 20 to 1,000 nm and more preferably from 20 to 150 nm to enhance the discharging stability and image quality such as optical density. The solid content includes particles such as resin particles and pigment particles. The particle diameter can be measured by using a particle size analyzer (Nanotrac Wave-UT151, available from MicrotracBEL Corp).

### Additive

The ink may further optionally include additives such as a surfactant, defoaming agent, preservative and fungicide, corrosion inhibitor, and pH regulator.

### Surfactant

A nonionic surfactant can be used as the surfactant in the present disclosure. The nonionic surfactant has no specific limit and can be suitably selected to suit to a particular application.

Specific examples include, but are not limited to, polyoxyethylene alkylene ethers, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides. These can be used alone or in combination. Of these, at least polyoxyethylne alkyl ether represented by Chemical Formula 1 below is contained.

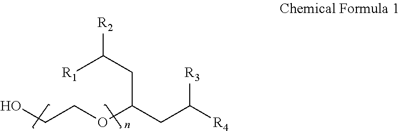

In Chemical Formula 1, R₁, R₂, R₃, and R₄ each, independently, represent hydrogen atoms or alkyl groups having 1 to 5 carbon atoms, and n represents an integer of from 4 to 10.

The alkyl group having 1 to 5 carbon atoms can be straight-chained or branch-chained.

Specific examples include, but are not limited to, a methyl group, ethyl group, propyl group, isopropyl group, n-butyl group, s-butyl group, isobutyl group, t-butyl group, pentyl group, isopentyl group, and neopentyl group.

The polyoxyethylene alkyl ether preferably has an HLB value of at least 7, and more preferably at least 9. The HLB value is an index indicating the balance between hydrophilicity and lipophilicity of a surfactant, calculated by the Griffin method; a smaller HLB value indicates higher lipophilicity, while a larger HLB value indicates higher hydrophilicity.

The polyoxyethylene alkyl ether may be used alone or in combination with two or more types.

There is no restriction on the number of carbon atoms in the alkyl group or the average number of moles of added ethylene oxide groups in the polyoxyethylene alkyl ether. Preferably, the alkyl group has approximately 11 to 15 carbon atoms, and more preferably approximately 12 to 15 carbon atoms. The average number of moles of added ethylene oxide groups is preferably around 3 to 15, and more preferably around 5 to 10.

Specific product examples of the polyoxyethylene alkyl ether include, but are not limited to, the following: EMULGEN 705, EMULGEN 707, EMULGEN 709, EMULGEN 1108, EMULGEN 1118S-70, EMULGEN 1135S-70, EMULGEN 1150S-60 (all available from Kao Corporation); ADEKA TOL LA-675B, ADEKA TOL LA-775 (both available from ADEKA CORPORATION); TRITON™ HW-1000 (available from The Dow Chemical Company); and SANNONIC SS-70 (available from Sanyo Chemical Industries, Ltd.).

The proportion of the surfactant in ink is not particularly limited and it can be suitably selected to suit a particular application. It is preferably from 0.001 to 5 percent by mass and more preferably from 0.05 percent by mass to 5 percent by mass to achieve good wettability and discharging stability and enhance the image quality.

### Defoaming Agent

The defoaming agent has no particular limit. Examples include, but are not limited to silicon-based defoaming agents, polyether-based defoaming agents, and aliphatic acid ester-based defoaming agents. These can be used alone or in combination. Of these, silicone-based defoaming agents are preferable to enhance the ability of braking foams.

### Preservatives and Fungicides

The preservatives and fungicides are not particularly limited. One specific example is 1,2-benzisothiazoline-3-one.

### Corrosion Inhibitor

The corrosion inhibitor has no particular limit. Specific examples include, but are not limited to, acid sulfites and sodium thiosulfates.

### pH Regulator

The pH regulator is not particularly limited as long as it can control the pH to 7 or greater. It includes, but is not limited to, amines such as diethanol amine and triethanol amine.

Properties of the ink are not particularly limited and they can be suitably selected to suit to a particular application. The ink preferably has properties, such as viscosity, surface tension, and pH, in the following ranges.

The ink preferably has a viscosity of from 5 to 30 mPa·s and more preferably from 5 to 25 mPa·s at 25 degrees C. to enhance the print density and text quality and achieve good dischargeability. Viscosity can be measured with equipment such as a rotatory viscometer, RE-80L, available from TOKI SANGYO CO., LTD. The measuring conditions are as follows:
Standard cone rotor (1°34′×R24)
Sample liquid amount: 1.2 mL
Rate of rotation: 50 rotations per minute (rpm)
25 degrees Celsius
Measuring time: three minutes.

The surface tension of the ink is preferably 35 mN/m or less and more preferably 32 mN/m or less at 25 degrees C. because the ink suitably levels on a recording medium and the ink dries in a short time.

pH of the ink is preferably from 7 to 12 and more preferably from 8 to 11 to prevent corrosion of the metal material in contact with liquid.

### Pre-Processing Fluid

The pre-processing fluid contains an aggregating agent, an organic solvent, water, and optional materials such as a surfactant, a defoaming agent, a pH regulator, a preservatives and fungicides, and a corrosion inhibitor.

The organic solvent, the surfactant, the defoaming agent, the pH regulator, the preservatives and fungicides, and the corrosion inhibitor are the same materials as those for use in ink and materials for use in known processing fluid.

The type of the aggregating agent is not particularly limited. For example, water-soluble cationic polymers, acids, and multi-valent metal salts are suitable.

### Aggregating Agent

The aggregating agent associates by an electric charge action with the coloring material in the ink to form an aggregate of the coloring material, and separates the coloring material from the liquid phase to promote attachment onto the recording medium. In addition, the aggregating agent in a pre-processing fluid reduces the occurrence of beading or bleeding even on a printing medium with a low ink-absorbency, which leads to forming quality images.

The pre-processing fluid contains the aggregating agent.

The content of the aggregating agent in the pre-processing fluid is from 1.0 to 20.0 percent by mass.

A content of the aggregating agent of at least 1.0 percent by mass to the total amount of the processing fluid improves color development.

A proportion of the aggregating agent of at most 20.0 percent by mass to the total amount of the processing fluid enhances the discharging stability.

Examples of the aggregating agent include, cationic polymers, polyvalent metal salts, and acids, with polyvalent metal salts being preferable.

### Polyvalent Metal Salt

A divalent or trivalent metal salt is preferable as the polyvalent metal salt to enhance the color development.

There is no specific limit to the divalent metal salt and it can be suitably selected to suit to a particular application.

Specific examples include, but are not limited to, calcium carbonate, calcium nitrate, calcium chlorinate, calcium acetate, calcium sulfate, magnesium chloride, magnesium acetate, and magnesium sulfate.

The trivalent metal salt has no specific limit and is suitably selected to suit to a particular application.

Specific examples include, but are not limited to, aluminum sulfate, aluminum silicate, and aluminum lactate.

The multivalent metal salt can be synthesized or procured.

Specific examples of commercially available multivalent metal salts include, but are not limited to, calcium acetate monohydrate (chemical name: calcium acetate, available from FUJIFILM Wako Pure Chemical Corporation, valency: divalent), magnesium acetate tetrahydrate (chemical name: magnesium acetate, available from FUJIFILM Wako Pure Chemical Corporation, valency: divalent), aluminum silicate (chemical name: aluminum silicate, available from FUJIFILM Wako Pure Chemical Corporation, valency: trivalent), and potassium acetate (chemical name: potassium acetate, available from FUJIFILM Wako Pure Chemical Corporation, valency: monovalent).

As the cationic polymer, quaternary ammonium salt type cationic polymers are preferable. Specific examples include, but are not limited to, polymers of dialkylaryl ammonium chloride, polymers of dialkyl aminoethyl (meth)acrylate quaternary ammonium salts, polymers of modified polyvinyl alcohol dialkyl ammonium salts, and polymers of dialkyl diallyl ammonium salts.

Specific examples of other water-soluble cationic polymers include, but are not limited to, cationic epichlorohydrin condensate, cationic specially-modified polyamine compounds, cationic polyamide polyamine compounds, cationic urea-formarine resin compounds, cationic polyacrylic amide compounds, cationic alkyl ketene dimers, cationic dicyane diamide compounds, cationic dicyan diamide-formarine condensation compounds, cationic dicyan diamide-polyamine condensation compounds, cationic polyvinyl formamide compounds, cationic polyvinyl pyridine compounds, cationic polyalkylene polyamine compounds, and cationic epoxy polyamide compounds.

As the acid, water-soluble aliphatic organic acids are preferable.

Specific examples thereof include, but are not limited to, lactic acid, malic acid, citric acid, dihydroxysuccinic acid, oxalic acid, malonic acid, succinic acid, adipic acid, acetic acid, propionic acid, butyric acid, valeric acid, gluconic acid, pyruvic acid, and fumaric acid.

In addition, amine salts of these organic acids are also suitable.

### Surfactant

Examples of the surfactant include, but are not limited to, silicone-based surfactants, fluorochemical surfactants, amphoteric surfactants, nonionic surfactants, and anionic surfactants.

The silicone-based surfactant has no specific limit and can be suitably selected to suit to a particular application. Of these, the surfactants not decomposable in a high pH environment are preferable. Examples include, but are not limited to, side chain modified polydimethyl siloxane, both terminal-modified polydimethyl siloxane, one-terminal-modified polydimethyl siloxane, and side-chain-both-terminal-modified polydimethyl siloxane. Silicone-based surfactants having a polyoxyethylene group or a polyoxyethylene polyoxypropylene group as a modification group are particularly preferable because such an aqueous surfactant demonstrates good properties. The silicone-based surfactant includes a polyether-modified silicone-based surfactant, one of which is a compound in which a polyalkylene oxide structure is introduced into the side chain of the Si site of dimethyl silooxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams.

Specific examples of the perfluoroalkyl sulfonic acid compounds include, but are not limited to, perfluoroalkyl sulfonic acid and salts of perfluoroalkyl sulfonic acid.

Specific examples of the perfluoroalkyl carbonic acid compounds include, but are not limited to, perfluoroalkyl carbonic acid and salts of perfluoroalkyl carbonic acid.

Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The proportion of the surfactant in the pre-processing fluid is not particularly limited and it can be suitably selected to suit a particular application. It is preferably from 0.001 to 5 percent by mass and more preferably from 0.05 percent by mass to 5 percent by mass to achieve good wettability and discharging stability and enhance the image quality.

### Recording Medium

The recording medium for use in printing is not particularly limited.

Specific examples include, but are not limited to, plain paper, glossy paper, special paper, cloth, film, transparent sheets, and printing paper for general purposes.

### Recorded Matter

The ink recorded matter of the present disclosure includes a recording medium and an image formed on the recording medium with the ink of the present disclosure.

The recorded matter is obtained by an inkjet recording device executing an inkjet recording method.

### Recording Device and Recording Method

The ink of the present disclosure can be suitably applied to various recording devices employing an inkjet recording method, such as printers, facsimile machines, photocopiers, multifunction peripherals (serving as a printer, a facsimile machine, and a photocopier), and solid freeform fabrication devices (3D printers, additive manufacturing devices).

In the present disclosure, the printing device and the printing method respectively represent a device capable of discharging ink and liquids such as processing fluids to a printing medium and a method of printing utilizing such a device. The recording (printing) medium refers to an item to which ink or processing fluids can be temporarily or permanently attached.

The recording (printing) device may furthermore optionally include a device relating to feeding, conveying, and ejecting a printing medium and other devices referred to as a pre-processing device and a post-processing device in addition to the head portion for discharging an ink.

The printing device and the printing method may further optionally include a heater for use in the heating process and a drier for use in the drying process. For example, the heating device and the drying device include devices including heating and drying the print surface of a printing medium and the opposite surface thereof. The heating device and the drying device are not particularly limited. For example, a fan heater and an infra-red heater can be used. Heating and drying can be conducted before, in the middle of, or after printing.

In addition, the printing device and the printing method are not limited to those producing meaningful visible images such as text and figures with ink. Devices for creating patterns like geometric design and 3D images are included.

In addition, the printing device includes both a serial type device with a movable liquid discharging head and a line type device with a fixed liquid discharging head, unless otherwise specified.

Furthermore, in addition to the desktop type, this printing device includes a device capable of printing images on a wide printing medium having, for example, A0 size, and a continuous printer capable of using continuous paper rolled up in a roll-like form as a printing medium.

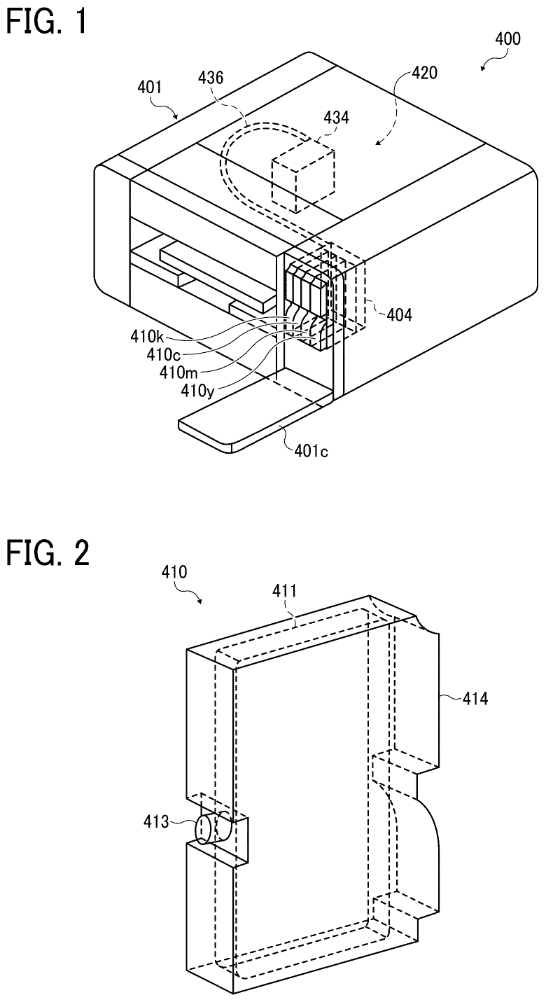

The recording (print) device is described using an example with reference to FIG. 1 and FIG. 2. FIG. 1 is a diagram illustrating a perspective view of the same device. FIG. 2 is a diagram illustrating a perspective view of a tank. An image forming apparatus 400 as an embodiment of the printing device is a serial image forming apparatus. The image forming apparatus 400 includes a mechanical unit 420 inside an exterior 401. Each ink accommodating unit (ink container) 411 of each tank 410 (410k, 410c, 410m, and 410y) for each color of black (K), cyan (C), magenta (M), and yellow (Y) is made of a packaging member such as aluminum laminate film. The ink accommodating unit 411 is housed in, for example, a plastic container housing unit 414. The tank 410 is used as an ink cartridge of each color.

A cartridge holder 404 is disposed on the rear side of the opening appearing when a cover 401c is opened. The tank 410 is detachably attached to the cartridge holder 404. This configuration enables each ink discharging outlet 413 of the tank 410 to communicate with a discharging head 434 for each color via a supplying tube 436 for each color so that the ink can be discharged from the discharging head 434 to a printing medium.

This printing device may include not only a portion for discharging ink but also a device referred to as a pre-processing device and a post-processing device.

As an example of the pre-processing device and the post-processing device, like the ink of black (K), cyan (C), magenta (M), and yellow (Y) ink, the pre-processing device and the post-processing device may further include a liquid accommodating unit including a pre-processing liquid or a post-processing liquid and a liquid discharging head to discharge the pre-processing liquid or the post-processing liquid according to an inkjet printing method.

As another example of the pre-processing device and the post-processing device, it is suitable to dispose a pre-processing device and a post-processing device not employing the inkjet printing method but a blade coating method, a roll coating method, or a spray coating method.

Notably, the ink and the processing fluid are applicable not only to the inkjet printing but can be widely applied in other methods. In addition to the inkjet printing, these substances are also applicable to blade coating, gravure coating, gravure offset coating, bar coating, roll coating, knife coating, air knife coating, comma coating, U comma coating, AKKU coating, smoothing coating, micro gravure coating, reverse roll coating, four roll coating. five roll coating, dip coating, curtain coating, slide coating, and die coating.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, embodiments of the present disclosure are described in detail with reference to Examples and Comparative Examples but are not limited thereto. “Parts” represents parts by mass and “percent” represents percent by mass unless otherwise specified in the following description.

### Preparation Example 1 of Pigment Dispersion

### Preparation of Cyan Pigment Dispersion

Cyan pigment dispersion was prepared in the same manner as in—Method A—of Pigment Surface Reforming Treatment disclosed in Japanese Unexamined Patent Application Publication No. 2012-207202.

Specifically, 20 g of C.I. Pigment Blue 15:3 (CHROMOFINE BLUE, available from Dainichiseika Color & Chemicals Mfg. Co., Ltd.), 20 mmol of the compound represented by the following Chemical Formula 2, and 200 mL of deionized water were mixed in a room temperature environment using Silverson mixer {(6,000 rpm (0.6 percent)} to obtain a slurry. In the case where the slurry obtained had a pH higher than 4, 20 mmol of nitric acid was added. Thirty (30) minutes later, 20 mmol of sodium nitrite dissolved in a minute amount of deionized water was slowly added to the slurry. Furthermore, the temperature was raised to 60 degrees Celsius while the mixture was stirred to allow reaction for one hour. The compound represented by Chemical Formula 2 illustrated below was added to the surface of C.I. Pigment Blue 15:3 to produce a reformed pigment. Thereafter, the pH was adjusted to by NaOH aqueous solution. Thirty minutes later, a reformed pigment dispersion was obtained 30 minutes later. The reformed pigment dispersion and deionized water were subjected to ultrafiltering utilizing dialysis membrane. Thereafter, the resulting filtrate was subjected to ultrasonic wave dispersion to obtain a cyan pigment dispersion (self-dispersion type) having a bisphosphonic acid group as a hydrophilic functional group to achieve a pigment concentration of 15 percent.

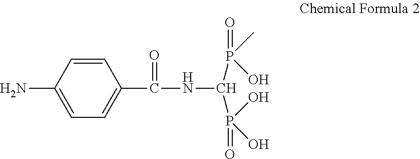 [SMILES: CP(=O)(O)C(NC(=O)c1ccc(N)cc1)P(=O)(O)O]

### Preparation Example 2 of Pigment Dispersion

### Preparation of Magenta Pigment Dispersion

A magenta pigment dispersion having a pigment concentration of 15 percent was obtained in the same manner as in Preparation Example of Cyan Pigment Dispersion except that 20 g of C.I. Pigment Blue 15:3 was replaced with 20 g of C.I. Pigment Red 122 (Toner Magenta EO02, available from Clariant Japan KK).

### Preparation Example 3 of Pigment Dispersion

### Preparation of Yellow Pigment Dispersion

A yellow pigment dispersion having a pigment concentration of 15 percent was obtained in the same manner as in Preparation Example of Cyan Pigment Dispersion except that 20 g of C.I. Pigment Blue 15:3 was replaced with 20 g of C.I. Pigment Yellow 74 (First Yellow 531, available from Dainichiseika Color & Chemicals Mfg. Co., Ltd.).

### Preparation Example 4 of Pigment Dispersion

### Preparation of Black Pigment Dispersion

A black pigment dispersion having a pigment concentration of 15 percent was obtained in the same manner as in Preparation Example of Cyan Pigment Dispersion except that 20 g of C.I. Pigment Blue 15:3 was replaced with 20 g of Carbon Black (NIPEX 160, available from degusa-Huls AG).

### Preparation Example 1 of Resin Particle

### Preparation of Liquid of Polycarbonate-based Urethane Resin Particles

In a nitrogen atmosphere, 1,500 g of polycarbonate diol (reaction product of 1,6-hexane diol and dimethyl carbonate, number average molecular weight Mn of 1,200), 220 g of 2,2-dimethylol propionic acid (DMPA), and 1,347 g of N-methyl pyrrolidone (NMP) were charged in a reaction container equipped with a stirrer, a reflux cooling tube, and a thermometer followed by heating to 60 degrees Celsius to dissolve DMPA.

Thereafter, 1,445 g of 4,4′-dicyclohexyl methane diisocyanate and 2.6 g of dibutyl tin dilaurylate (catalyst) were added thereto followed by heating to 90 degrees Celsius to complete urethanification reaction in five hours. As a result, an isocyanate-terminated urethane prepolymer was obtained. This reaction mixture was cooled down to 80 degrees Celsius followed by admixing 149 g of triethyl amine. A total of 4,340 g of the resulting mixture was extracted and charged in a liquid mixture of 5,400 g of water and 15 g of triethyl amine during vigorous stirring.

Thereafter, 1,500 g of ice and 626 g of 35 percent 2-methyl-1,5-pentane diamine aqueous solution were added to conduct chain elongation reaction followed by distillation away of the solvent in such a manner that the solid portion concentration was 40 percent, thus obtaining Polycarbonate-based Urethane Resin Particle Dispersion.

The glass transition temperature Tg of Polycarbonate-based Urethane Resin Particle Dispersion was measured, which was −20 degrees Celsius.

### Preparation Example 2 of Resin Particle

### Preparation of Polyester-based Urethane Resin Particle Dispersion

Polyester-based Urethane Resin Particle Dispersion with a solid content of 30 percent was obtained in the same manner as in Preparation Example 1 of Resin Particle except that polycarbonate diol (the reaction product of 1,6-hexanediol and dimethyl carbonate; number average molecular weight Mn: 1,200) was replaced with polyester polyol (Polylight OD-X-2251, available from DIC Corporation; weight average molecular weight: 2,000).

For Polyester-based Urethane Resin Particle Dispersion obtained, the Tg measured in the same manner as in Preparation Example 1 of Polycarbonate-based Urethane Resin Particle Dispersion 1 was 57 degrees Celsius.

### Preparation of Color Ink 1

Color Ink 1 was prepared by mixing and stirring the following components, then filtering through a polypropylene filter with an average pore size of 1.0 μm:
20 percent Cyan Pigment Dispersion (pigment solid content concentration: 15 percent),
2.5 percent Polycarbonate-based Urethane Resin Particle Dispersion (solid content concentration: 40 percent)
33.3 percent Polyester-based Urethane Resin Particle Dispersion (solid content concentration: 30 percent)
15.0 percent 3-methoxy-N,N-dimethylpropanamide (available from Tokyo Chemical Industry Co., Ltd.)
5.0 percent 1,2-hexanediol (available from Tokyo Chemical Industry Co., Ltd.)
5.0 percent propylene glycol monomethyl ether (available from Tokyo Chemical Industry Co., Ltd.)
10.0 percent diethylene glycol monobutyl ether (available from Tokyo Chemical Industry Co., Ltd.)
3.0 percent polyoxyethylene alkyl ether (trade name: TRITON HW-1000, available from Dow Chemical Company)
1.0 percent defoaming agent (trade name: Surfynol ADO1, available from Nissin Chemical Industry Co., Ltd.)
0.25 percent 2-amino-2-ethyl-1,3-propanediol (pH regulator, available from Tokyo Chemical Industry Co., Ltd.)
0.05 percent 2-cyclohexylaminoethanesulfonic acid (pH buffering agent, available from Tokyo Chemical Industry Co., Ltd.)
0.1 percent antimicrobial agent (preservative) (trade name: Proxel LV, available from Arch Chemicals Japan Co., Ltd.)
Ultra-pure water as balance

### Preparation of Color Inks 2 to 41

Color Inks 2 to 41 were prepared in the same manner as in Color Ink 1 according to the formulations shown in Tables 1-1 to 1-4. The unit of the value of each component in Tables is percent by mass.

### Preparation of Pre-processing Fluid 1

Pre-processing Fluid 1 was prepared by mixing and stirring the following components, then filtering through a polypropylene filter with an average pore size of 1.0 μm:
18.0 percent 1,2-propanediol (available from Tokyo Chemical Industry Co., Ltd.)
15.0 percent 3-methoxy-3-methyl-1-butanol (available from Tokyo Chemical Industry Co., Ltd.)
5.0 percent 2,3-butanediol (available from Tokyo Chemical Industry Co., Ltd.)
3.0 percent 2-ethyl-1,3-hexanediol (available from Tokyo Chemical Industry Co., Ltd.)
2.0 percent polyether-modified surfactant (product name: WET270, available from TEGO)
3.0 percent silicone-based surfactant (product name: Silface SAG503A, available from by Nissin Chemical Industry Co., Ltd.)
1.0 percent defoaming agent (product name: Surfynol ADO1, available from Nissin Chemical Industry Co., Ltd.)
10.0 percent magnesium acetate tetrahydrate (aggregating agent, available from Fujifilm Wako Pure Chemical Corporation)
0.25 percent 2-amino-2-ethyl-1,3-propanediol (pH regulator, available from Tokyo Chemical Industry Co., Ltd.)
0.05 percent 2-cyclohexylaminoethanesulfonic acid (pH buffering agent, available from Tokyo Chemical Industry Co., Ltd.)
0.1 percent antimicrobial agent (preservative) (product name: Proxel L1, available from Arch Chemicals Japan Co., Ltd.)
Ultra-pure water as a balance.

### Preparation of Pre-Processing Fluids 2 to 16

Pre-processing Fluids 2 to 16 were prepared in the same manner as in Pre-processing Fluid 1 according to the formulations shown in Tables 2-1 to 2-2. The unit of the value of each component in Tables is percent by mass.

TABLE 1-1

| | | | | | Boiling |
|---|---|---|---|---|---|
| | | | | Molecular | point |
| | | | SP value | weight | (degrees |
| Component | | Medicine | (cal/cm³)^{1/2} | (g/mol) | Celsius) |
| Organic | Organic solvent | 3-methoxy- | 10.44 | 131.17 | 215 |
| solvent | other than | N,N-dimethyl | | | |
| | glycolether | propanamide | | | |
| | | 1,2-hexane | 13.37 | 118.17 | 170 |
| | | diol | | | |
| | | Triethylene | 13.58 | 150.18 | 287 |
| | | glycol | | | |
| | | Glycerin | 20.02 | 92.09 | 290 |
| | | Diethylene | 14.97 | 106.12 | 244 |
| | | glycol | | | |
| | Glycol ether | Propylene | 11.27 | 90.13 | 121 |
| | | glycol | | | |
| | | monomethyl | | | |
| | | ether (C = 4) | | | |
| | | Diethylene | 10.51 | 162.23 | 231 |
| | | glycol | | | |
| | | monobutyl | | | |
| | | ether (C = 8) | | | |
| | | Diethylene | 10.94 | 134.18 | 196 |
| | | glycol | | | |
| | | monoethyl | | | |
| | | ether (C = 6) | | | |
| | | Ethylene | 10.92 | 76.09 | 124.1 |
| | | glycol | | | |
| | | monomethyl | | | |
| | | ether (C = 3) | | | |
| | | Diethylene | 11.42 | 120.02 | 193 |
| | | glycol | | | |
| | | monomethyl | | | |
| | | ether (C = 5) | | | |
| | | Dipropylene | 9.99 | 190.28 | 230 |
| | | glycol | | | |
| | | monobutyl | | | |
| | | ether (C = 10) | | | |
| | | Diethylene | 8.29 | 218.34 | 255 |
| | | glycol dibutyl | | | |
| | | ether (C = 12) | | | |

Content of glycol ether
Mixed SP value (cal/cm³)^{0.5} (=SP value
of organic solvent A × molar fraction of
organic solvent A) + . . .
Amount of organic solvent

| | | | |
|---|---|---|---|
| Surfactant | Polyoxyethylene | TRITON HW- | HLB: 10.8 |
| | alkyl ether (R = | 1000 | |
| | 12 to 15) | Emulgen 705 | HLB: 10.5 |
| | | EMULGEN | HLB: 16.4 |
| | | 1118S-70 | |
| | | SANNONIC | HLB: 12.1 |
| | | SS70 | |
| | Silicone-based | WET-270 | |
| | | SAG503A | |

| Antibacterial agent | PROXEL LV |
|---|---|
| Defoaming agent | AD01 |
| Water | Highly pure |
| | water |
| pH regulator | AEPD |
| pH buffering agent | CHES |
| Resin | Polycarbonate- |
| | based |
| | Urethane |
| | Resin Particle |
| | Dispersion |
| | (Tg: −20 |
| | degrees |
| | Celsius) |
| | Polyester- |
| | based |
| | Urethane |
| | Resin Particle |
| | Dispersion |
| | (Tg: 57 |
| | degrees |
| | Celsius) |
| | DAOTAN |
| | VTW1237 |
| | (Tg: 7 degrees |
| | Celsius) |
| | DAOTAN- |
| | TW1225 (Tg: |
| | 40 degrees |
| | Celsius) |
| Pigment dispersion | Cyan |
| | dispersion |
| | Magenta |
| | dispersion |
| | Yellow |
| | dispersion |
| | Black |
| | dispersion |

P/R
Color ink

| 1 | 2 | 3 | 4 | 5 | 6 | 7 | 8 | 9 | 10 |
|---|---|---|---|---|---|---|---|---|---|
| 15.0 | 15.0 | 15.0 | 15.0 | 15.0 | 15.0 | 15.0 | 15.0 | 15.0 | 15.0 |
| 5.0 | 5.0 | 5.0 | 5.0 | 5.0 | 5.0 | 5.0 | 5.0 | 5.0 | 5.0 |
| 5.0 | 5.0 | 5.0 | 5.0 | 5.0 | 5.0 | 5.0 | 2.5 | 5.0 | 5.0 |
| 10.0 | 10.0 | 10.0 | 10.0 | | 10.0 | 10.0 | 7.5 | 15.0 | 10.0 |
| | | | | 10.0 | | | | | |
| 15.0 | 15.0 | 15.0 | 15.0 | 15.0 | 15.0 | 15.0 | 10.0 | 20.0 | 15.0 |
| 11.08 | 11.08 | 11.08 | 11.08 | 10.99 | 11.08 | 11.08 | 11.09 | 11.02 | 11.08 |
| 35.0 | 35.0 | 35.0 | 35.0 | 35.0 | 35.0 | 35.0 | 30.0 | 40.0 | 35.0 |
| 3.0 | 3.0 | 3.0 | 3.0 | 3.0 | 1.0 | 5.0 | | | |
| | | | | | | | 3.0 | | |
| | | | | | | | | 3.0 | |
| | | | | | | | | | 3.0 |
| 0.1 | 0.1 | 0.1 | 0.1 | 0.1 | 0.1 | 0.1 | 0.1 | 0.1 | 0.1 |
| 1.0 | 1.0 | 1.0 | 1.0 | 1.0 | 1.0 | 1.0 | 1.0 | 1.0 | 1.0 |
| 46.6 | 46.6 | 46.6 | 46.6 | 46.6 | 48.6 | 44.6 | 51.6 | 41.6 | 46.8 |
| 0.25 | 0.25 | 0.25 | 0.25 | 0.25 | 0.25 | 0.25 | 0.25 | 0.25 | 0.25 |
| 0.05 | 0.05 | 0.05 | 0.05 | 0.05 | 0.05 | 0.05 | 0.05 | 0.05 | 0.05 |
| 1.0 | 1.0 | 1.0 | 1.0 | 1.0 | 1.0 | 1.0 | 1.0 | 1.0 | 1.0 |
| 10.0 | 10.0 | 10.0 | 10.0 | 10.0 | 10.0 | 10.0 | 10.0 | 10.0 | 10.0 |
| 3.0 | | | | 3.0 | 3.0 | 3.0 | 3.0 | 3.0 | 2.8 |
| | 3.0 | | | | | | | | |
| | | 3.0 | | | | | | | |
| | | | 3.0 | | | | | | |
| 0.27 | 0.27 | 0.27 | 0.27 | 0.27 | 0.27 | 0.27 | 0.27 | 0.27 | 0.25 |

TABLE 1-2

| | | | | | Boiling |
|---|---|---|---|---|---|
| | | | | Molecular | point |
| | | | SP value | weight | (degrees |
| Component | | Medicine | (cal/cm³)^{1/2} | (g/mol) | Celsius) |
| Organic | Organic solvent | 3-methoxy- | 10.44 | 131.17 | 215 |
| solvent | other than | N,N-dimethyl | | | |
| | glycolether | propanamide | | | |
| | | 1,2-hexane | 13.37 | 118.17 | 170 |
| | | diol | | | |
| | | Triethylene | 13.58 | 150.18 | 287 |
| | | glycol | | | |
| | | Glycerin | 20.02 | 92.09 | 290 |
| | | Diethylene | 14.97 | 106.12 | 244 |
| | | glycol | | | |
| | Glycol ether | Propylene | 11.27 | 90.13 | 121 |
| | | glycol | | | |
| | | monomethyl | | | |
| | | ether (C = 4) | | | |
| | | Diethylene | 10.51 | 162.23 | 231 |
| | | glycol | | | |
| | | monobutyl | | | |
| | | ether (C = 8) | | | |
| | | Diethylene | 10.94 | 134.18 | 196 |
| | | glycol | | | |
| | | monoethyl | | | |
| | | ether (C = 6) | | | |
| | | Ethylene | 10.92 | 76.09 | 124.1 |
| | | glycol | | | |
| | | monomethyl | | | |
| | | ether (C = 3) | | | |
| | | Diethylene | 11.42 | 120.02 | 193 |
| | | glycol | | | |
| | | monomethyl | | | |
| | | ether (C = 5) | | | |
| | | Dipropylene | 9.99 | 190.28 | 230 |
| | | glycol | | | |
| | | monobutyl | | | |
| | | ether (C = 10) | | | |
| | | Diethylene | 8.29 | 218.34 | 255 |
| | | glycol dibutyl | | | |
| | | ether (C = 12) | | | |

Content of glycol ether
Mixed SP value (cal/cm³)^{0.5} (=SP value of organic solvent A ×
molar fraction of organic solvent A) + . . .
Amount of organic solvent

| | | | |
|---|---|---|---|
| Surfactant | Polyoxyethylene | TRITON HW- | HLB: 10.8 |
| | alkyl ether | 1000 | |
| | (R = 12 to 15) | Emulgen 705 | HLB: 10.5 |
| | | EMULGEN | HLB: 16.4 |
| | | 1118S-70 | |
| | | SANNONIC | HLB: 12.1 |
| | | SS70 | |
| | Silicone-based | WET-270 | |
| | | SAG503A | |

| Antibacterial agent | PROXEL LV |
|---|---|
| Defoaming agent | AD01 |
| Water | Highly pure |
| | water |
| pH regulator | AEPD |
| pH buffering agent | CHES |
| Resin | Polycarbonate- |
| | based |
| | Urethane |
| | Resin Particle |
| | Dispersion |
| | (Tg: −20 |
| | degrees Celsius) |
| | Polyester- |
| | based |
| | Urethane |
| | Resin Particle |
| | Dispersion |
| | (Tg: 57 |
| | degrees Celsius) |
| | DAOTAN |
| | VTW1237 |
| | (Tg: 7 |
| | degrees Celsius) |
| | DAOTAN- |
| | TW1225 |
| | (Tg: 40 |
| | degrees Celsius) |
| Pigment dispersion | Cyan |
| | dispersion |
| | Magenta |
| | dispersion |
| | Yellow |
| | dispersion |
| | Black |
| | dispersion |

P/R
Color ink

| 11 | 12 | 13 | 14 | 15 | 16 | 17 | 18 | 19 | 20 |
|---|---|---|---|---|---|---|---|---|---|
| 15.0 | 15.0 | 15.0 | 15.0 | 5.0 | 15.0 | 15.0 | 15.0 | 15.0 | 15.0 |
| 5.0 | 5.0 | 5.0 | 5.0 | 4.0 | 5.0 | 5.0 | 5.0 | 5.0 | 5.0 |
| | | | | | | | | | 5.0 |
| 5.0 | 5.0 | 5.0 | 5.0 | 5.0 | 5.0 | 5.0 | 5.0 | 5.0 | 5.0 |
| 10.0 | 10.0 | 10.0 | 10.0 | 6.0 | 10.0 | | | | 5.0 |
| | | | | | | 10.0 | | | |
| | | | | | | | 10.0 | | |
| | | | | | | | | 10.0 | |
| | | | | | | | | | 10.0 |
| 15.0 | 15.0 | 15.0 | 15.0 | 11.0 | 15.0 | 15.0 | 15.0 | 15.0 | 20.0 |
| 11.08 | 11.08 | 11.08 | 11.08 | 11.34 | 11.08 | 11.16 | 11.12 | 11.29 | 10.70 |
| 35.0 | 35.0 | 35.0 | 35.0 | 20.0 | 35.0 | 35.0 | 35.0 | 35.0 | 45.0 |
| 3.0 | 3.0 | 3.0 | 3.0 | 3.0 | 3.0 | 3.0 | 3.0 | 3.0 | 3.0 |
| 0.1 | 0.1 | 0.1 | 0.1 | 0.1 | 0.1 | 0.1 | 0.1 | 0.1 | 0.1 |
| 1.0 | 1.0 | 1.0 | 1.0 | 1.0 | 1.0 | 1.0 | 1.0 | 1.0 | 1.0 |
| 53.1 | 50.6 | 51.6 | 48.6 | 61.6 | 46.6 | 46.6 | 46.6 | 46.6 | 36.6 |
| 0.25 | 0.25 | 0.25 | 0.25 | 0.25 | 0.25 | 0.25 | 0.25 | 0.25 | 0.25 |
| 0.05 | 0.05 | 0.05 | 0.05 | 0.05 | 0.05 | 0.05 | 0.05 | 0.05 | 0.05 |
| 1.0 | 1.0 | 0.5 | 0.5 | 1.0 | 1.0 | 1.0 | 1.0 | 1.0 | 1.0 |
| 2.5 | 5.0 | 2.5 | 2.5 | 10.0 | | 10.0 | 10.0 | 10.0 | 10.0 |
| | | | | | 10.0 | | | | |
| 4.0 | 4.0 | 6.0 | 9.0 | 3.0 | 3.0 | 3.0 | 3.0 | 3.0 | 3.0 |
| 1.14 | 0.67 | 2.00 | 3.00 | 0.27 | 3.00 | 0.27 | 0.27 | 0.27 | 0.27 |

TABLE 1-3

| | | | | | Boiling |
|---|---|---|---|---|---|
| | | | | Molecular | point |
| | | | SP value | weight | (degrees |
| Component | | Medicine | (cal/cm³)^{1/2} | (g/mol) | Celsius) |
| Organic | Organic solvent | 3-methoxy- | 10.44 | 131.17 | 215 |
| solvent | other than | N,N-dimethyl | | | |
| | glycolether | propanamide | | | |
| | | 1,2-hexane | 13.37 | 118.17 | 170 |
| | | diol | | | |
| | | Triethylene | 13.58 | 150.18 | 287 |
| | | glycol | | | |
| | | Glycerin | 20.02 | 92.09 | 290 |
| | | Diethylene | 14.97 | 106.12 | 244 |
| | | glycol | | | |
| | Glycol ether | Propylene | 11.27 | 90.13 | 121 |
| | | glycol | | | |
| | | monomethyl | | | |
| | | ether (C = 4) | | | |
| | | Diethylene | 10.51 | 162.23 | 231 |
| | | glycol | | | |
| | | monobutyl | | | |
| | | ether (C = 8) | | | |
| | | Diethylene | 10.94 | 134.18 | 196 |
| | | glycol | | | |
| | | monoethyl | | | |
| | | ether (C = 6) | | | |
| | | Ethylene | 10.92 | 76.09 | 124.1 |
| | | glycol | | | |
| | | monomethyl | | | |
| | | ether (C = 3) | | | |
| | | Diethylene | 11.42 | 120.02 | 193 |
| | | glycol | | | |
| | | monomethyl | | | |
| | | ether (C = 5) | | | |
| | | Dipropylene | 9.99 | 190.28 | 230 |
| | | glycol | | | |
| | | monobutyl | | | |
| | | ether (C = 10) | | | |
| | | Diethylene | 8.29 | 218.34 | 255 |
| | | glycol dibutyl | | | |
| | | ether (C = 12) | | | |

Content of glycol ether
Mixed SP value (cal/cm³)^{0.5} (=SP value of organic solvent A ×
molar fraction of organic solvent A) + . . .
Amount of organic solvent

| | | | |
|---|---|---|---|
| Surfactant | Polyoxyethylene | TRITON HW- | HLB: 10.8 |
| | alkyl ether | 1000 | |
| | (R = 12 to 15) | Emulgen 705 | HLB: 10.5 |
| | | EMULGEN | HLB: 16.4 |
| | | 1118S-70 | |
| | | SANNONIC | HLB: 12.1 |
| | | SS70 | |
| | Silicone-based | WET-270 | |
| | | SAG503A | |

| Antibacterial agent | PROXEL LV |
|---|---|
| Defoaming agent | AD01 |
| Water | Highly pure |
| | water |
| pH regulator | AEPD |
| pH buffering agent | CHES |
| Resin | Polycarbonate- |
| | based |
| | Urethane |
| | Resin Particle |
| | Dispersion |
| | (Tg: −20 |
| | degrees Celsius) |
| | Polyester- |
| | based |
| | Urethane |
| | Resin Particle |
| | Dispersion |
| | (Tg: 57 |
| | degrees Celsius) |
| | DAOTAN |
| | VTW1237 |
| | (Tg: 7 |
| | degrees Celsius) |
| | DAOTAN- |
| | TW1225 |
| | (Tg: 40 |
| | degrees Celsius) |
| Pigment dispersion | Cyan |
| | dispersion |
| | Magenta |
| | dispersion |
| | Yellow |
| | dispersion |
| | Black |
| | dispersion |

P/R
Color ink

| 21 | 22 | 23 | 24 | 25 | 26 | 27 | 28 | 29 | 30 |
|---|---|---|---|---|---|---|---|---|---|
| 14.0 | 15.0 | 5.0 | 16.0 | 15.0 | 15.0 | 15.0 | 15.0 | 15.0 | 15.0 |
| 1.0 | 25.0 | 4.0 | 5.0 | 5.0 | 5.0 | 5.0 | 10.0 | 5.0 | 5.0 |
| | | | | | | | | 10.0 | |
| | | | | | | | | | 10.0 |
| | | | | | | 5.0 | | | |
| | 5.0 | 5.0 | 8.0 | 5.0 | 5.0 | 5.0 | | | |
| | 5.0 | 5.0 | 12.0 | 10.0 | 10.0 | 10.0 | | | |
| | | | | | | | 10.0 | | |
| 10.0 | | | | | | | 10.0 | | |
| 10.0 | 10.0 | 10.0 | 20.0 | 15.0 | 15.0 | 15.0 | 20.0 | 0.0 | 0.0 |
| 9.98 | 12.06 | 11.37 | 11.06 | 11.08 | 11.08 | 11.08 | 11.69 | 11.93 | 14.83 |
| 25.0 | 50.0 | 19.0 | 41.0 | 35.0 | 35.0 | 40.0 | 45.0 | 30.0 | 30.0 |
| 3.0 | 3.0 | 3.0 | 3.0 | 3.0 | 3.0 | 1.0 | 3.0 | 3.0 | 3.0 |
| 0.1 | 0.1 | 0.1 | 0.1 | 0.1 | 0.1 | 0.1 | 0.1 | 0.1 | 0.1 |
| 1.0 | 1.0 | 1.0 | 1.0 | 1.0 | 1.0 | 1.0 | 1.0 | 1.0 | 1.0 |
| 56.6 | 37.1 | 62.6 | 40.6 | 47.6 | 47.6 | 43.6 | 31.6 | 51.6 | 51.6 |
| 0.25 | 0.25 | 0.25 | 0.25 | 0.25 | 0.25 | 0.25 | 0.25 | 0.25 | 0.25 |
| 0.05 | 0.05 | 0.05 | 0.05 | 0.05 | 0.05 | 0.05 | 0.05 | 0.05 | 0.05 |
| 1.0 | 0.5 | 1.0 | 1.0 | 10.0 | | 1.0 | 2.0 | 1.0 | 1.0 |
| 10.0 | 5.0 | 10.0 | 10.0 | | | 10.0 | 13.0 | 10.0 | 10.0 |
| | | | | | 10.0 | | | | |
| 3.0 | 3.0 | 3.0 | 3.0 | 3.0 | 3.0 | 3.0 | 4.0 | 3.0 | 3.0 |
| 0.27 | 0.55 | 0.27 | 0.27 | 0.30 | 0.30 | 0.27 | 0.27 | 0.27 | 0.27 |

TABLE 1-4

| | | | | | Boiling |
|---|---|---|---|---|---|
| | | | | Molecular | point |
| | | | SP value | weight | (degrees |
| Component | | Medicine | (cal/cm³)^{1/2} | (g/mol) | Celsius) |
| Organic | Organic solvent | 3-methoxy- | 10.44 | 131.17 | 2.15 |
| solvent | other than | N,N-dimethyl | | | |
| | glycolether | propanamide | | | |
| | | 1,2-hexane | 13.37 | 118.17 | 170 |
| | | diol | | | |
| | | Triethylene | 13.58 | 150.18 | 287 |
| | | glycol | | | |
| | | Glycerin | 20.02 | 92.09 | 290 |
| | | Diethylene | 14.97 | 106.12 | 244 |
| | | glycol | | | |
| | Glycol ether | Propylene | 11.27 | 90.13 | 121 |
| | | glycol | | | |
| | | monomethyl | | | |
| | | ether (C = 4) | | | |
| | | Diethylene | 10.51 | 162.23 | 231 |
| | | glycol | | | |
| | | monobutyl | | | |
| | | ether (C = 8) | | | |
| | | Diethylene | 10.94 | 134.18 | 196 |
| | | glycol | | | |
| | | monoethyl | | | |
| | | ether (C = 6) | | | |
| | | Ethylene | 10.92 | 76.09 | 124.1 |
| | | glycol | | | |
| | | monomethyl | | | |
| | | ether (C = 3) | | | |
| | | Diethylene | 11.42 | 120.02 | 193 |
| | | glycol | | | |
| | | monomethyl | | | |
| | | ether (C = 5) | | | |
| | | Dipropylene | 9.99 | 190.28 | 230 |
| | | glycol | | | |

| monobutyl | | | |
|---|---|---|---|
| ether (C = 10) | | | |
| Diethylene | 8.29 | 218.34 | 255 |
| glycol dibutyl | | | |
| ether (C = 12) | | | |

Content of glycol ether
Mixed SP value (cal/cm³)^{0.5} (=SP value of organic solvent A ×
molar fraction of organic solvent A) + . . .
Amount of organic solvent

| | | | |
|---|---|---|---|
| Surfactant | Polyoxyethylene | TRITON HW- | HLB: 10.8 |
| | alkyl ether | 1000 | |
| | (R = 12 to 15) | Emulgen 705 | HLB: 10.5 |
| | | EMULGEN | HLB: 16.4 |
| | | 1118S-70 | |
| | | SANNONIC | HLB: 12.1 |
| | | SS70 | |
| | Silicone-based | WET-270 | |
| | | SAG503A | |

| Antibacterial agent | PROXEL LV |
|---|---|
| Defoaming agent | AD01 |
| Water | Highly pure |
| | water |
| pH regulator | AEPD |
| pH buffering agent | CHES |
| Resin | Polycarbonate- |
| | based |
| | Urethane |
| | Resin Particle |
| | Dispersion |
| | (Tg: −20 |
| | degrees Celsius) |
| | based |
| | Urethane |
| | Resin Particle |
| | Dispersion |
| | (Tg: 57 |
| | degrees Celsius) |
| | DAOTAN |
| | VTW1237 |
| | (Tg: 7 |
| | degrees Celsius) |
| | DAOTAN- |
| | TW1225 |
| | (Tg: 40 |
| | degrees Celsius) |
| Pigment dispersion | Cyan |
| | dispersion |
| | Magenta |
| | dispersion |
| | Yellow |
| | dispersion |
| | Black |
| | dispersion |

P/R
Color ink

| 31 | 32 | 33 | 34 | 35 | 36 | 37 | 38 | 39 | 40 | 41 |
|---|---|---|---|---|---|---|---|---|---|---|
| 15.0 | 15.0 | 15.0 | 15.0 | 15.0 | 15.0 | 15.0 | 15.0 | 15.00 | 15.00 | 15.00 |
| 5.0 | 5.0 | 5.0 | 5.0 | 5.0 | 5.0 | 5.0 | 5.0 | 5.00 | 5.00 | 5.00 |
| 10.0 | | | | | | | | | | |
| | 5.0 | 5.0 | 5.0 | 5.0 | 2.0 | 7.5 | 5.0 | 5.0 | 5.0 | 5.0 |
| | 10.0 | 10.0 | 10.0 | 10.0 | 7.9 | 12.6 | 10.0 | 10.0 | 10.0 | 10.0 |
| 0.0 | 15.0 | 15.0 | 15.0 | 15.0 | 9.9 | 20.1 | 15.0 | 15.0 | 15.0 | 15.0 |
| 12.64 | 11.08 | 11.08 | 11.08 | 11.08 | 11.08 | 11.07 | 11.08 | 11.08 | 11.08 | 11.08 |
| 30.0 | 35.0 | 35.0 | 35.0 | 35.0 | 29.9 | 40.1 | 35.0 | 35.0 | 35.0 | 35.0 |
| 3.0 | | | 0.9 | 5.1 | 3.0 | 3.0 | 3.0 | 3.0 | | |
| | | | | | | | | | 3.0 | |
| | | | | | | | | | | 3.0 |
| 0.1 | 0.1 | 0.1 | 0.1 | 0.1 | 0.1 | 0.1 | 0.1 | 0.1 | 0.1 | 0.1 |
| 1.0 | 1.0 | 1.0 | 1.0 | 1.0 | 1.0 | 1.0 | 1.0 | 1.0 | 1.0 | 1.0 |
| 51.6 | 49.6 | 60.6 | 48.7 | 44.5 | 51.7 | 41.5 | 45.1 | 48.6 | 46.6 | 46.6 |
| 0.25 | 0.25 | 0.25 | 0.25 | 0.25 | 0.25 | 0.25 | 0.25 | 0.25 | 0.25 | 0.25 |
| 0.05 | 0.05 | 0.05 | 0.05 | 0.05 | 0.05 | 0.05 | 0.05 | 0.05 | 0.05 | 0.05 |
| 1.0 | 1.0 | | 1.0 | 1.0 | 1.0 | 1.0 | 1.5 | 0.5 | 1.0 | 1.0 |
| 10.0 | 10.0 | | 10.0 | 10.0 | 10.0 | 10.0 | 11.0 | 2.5 | 10.0 | 10.0 |
| 3.0 | 3.0 | 3.0 | 3.0 | 3.0 | 3.0 | 3.0 | 3.0 | 9.1 | 3.0 | 3.0 |
| 0.27 | 0.27 | — | 0.27 | 0.27 | 0.27 | 0.27 | 0.24 | 3.02 | 0.27 | 0.27 |

TABLE 2-1

| | | | | | Boiling |
|---|---|---|---|---|---|
| | | | | Molecular | point |
| | | | SP value | weight | (degrees |
| Component | | Medicine | (cal/cm³)^{0.5} | (g/mol) | Celsius) |
| Solvent | Organic | 1,2-propane | 15.91 | 76.09 | 188.2 |
| | solvent | diol | | | |
| | other than | 3-methoxy- | 10.92 | 118.176 | 174 |
| | glycolether | 3-methyl-1- | | | |
| | | butanol | | | |
| | | 2,3- | 14.60 | 90.121 | 177 |
| | | butanediol | | | |
| | | 2-ethyl-1,3- | 11.72 | 146.2 | 244 |
| | | hexanediol | | | |
| | | 3-methoxy- | 9.19 | 131.17 | 215 |
| | | N,N- | | | |
| | | dimethyl | | | |
| | | propanamide | | | |
| | | 1,2-hexane | 12.59 | 118.17 | 170 |
| | | diol | | | |
| | Glycol | Propylene | 10.19 | 90.13 | 121 |
| | ether | glycol | | | |
| | | monomethyl | | | |
| | | ether | | | |
| | | Diethylene | 10.7 | 162.23 | 231 |
| | | glycol | | | |
| | | monobutyl | | | |
| | | ether | | | |
| | | Triethylene | 13.58 | 150.18 | 287 |
| | | glycol | | | |
| | | Glycerin | 20.02 | 92.09 | 290 |
| | | Diethylene | 14.97 | 106.12 | 244 |
| | | glycol | | | |

Mixed SP value (cal/cm³)^{0.5} (=SP value of organic solvent A ×
molar fraction of organic solvent A) + . . .

| Surfactant | TRITON |
|---|---|
| | HW-1000 |
| | WET-270 |
| | SAG503A |
| Antibacterial agent | PROXEL LV |
| Defoaming agent | AD01 |
| Water | Highly pure |
| | water |
| aggregating agent | Magnesium |
| | acetate |
| | Aluminum |
| | nitrate |
| | Magnesium |
| | nitrate |
| | Magnesium |
| | sulfate |
| | Citric acid |
| | Acetic acid |
| | Polyethylene |
| | imine |
| pH regulator | AEPD |
| pH buffering agent | CHES |

Pre-processing fluid

| 1 | 2 | 3 | 4 | 5 | 6 | 7 | 8 |
|---|---|---|---|---|---|---|---|
| 18.0 | 18.0 | 18.0 | 18.0 | 18.0 | 18.0 | 18.0 | 18.0 |
| 15.0 | 15.0 | 15.0 | 15.0 | 15.0 | 15.0 | 15.0 | 15.0 |
| 5.0 | 5.0 | 5.0 | 5.0 | 5.0 | 5.0 | 5.0 | 5.0 |
| 3.0 | 3.0 | 3.0 | 3.0 | 3.0 | 3.0 | 3.0 | 3.0 |
| 14.11 | 14.11 | 14.11 | 14.11 | 14.11 | 14.11 | 14.11 | 14.11 |
| 2.0 | 2.0 | 2.0 | 2.0 | 2.0 | 2.0 | 2.0 | 2.0 |
| 3.0 | 3.0 | 3.0 | 3.0 | 3.0 | 3.0 | 3.0 | 3.0 |
| 0.1 | 0.1 | 0.1 | 0.1 | 0.1 | 0.1 | 0.1 | 0.1 |
| 1.0 | 1.0 | 1.0 | 1.0 | 1.0 | 1.0 | 1.0 | 1.0 |
| 42.6 | 42.6 | 42.6 | 47.6 | 42.6 | 42.6 | 42.6 | 32.6 |
| 10.0 | | | | | | | 20.0 |
| | | | 5.0 | | | | |
| | 10.0 | | | | | | |
| | | 10.0 | | | | | |
| | | | | 10.0 | | | |
| | | | | | 10.0 | | |
| | | | | | | 10.0 | |
| 0.25 | 0.25 | 0.25 | 0.25 | 0.25 | 0.25 | 0.25 | 0.25 |
| 0.05 | 0.05 | 0.05 | 0.05 | 0.05 | 0.05 | 0.05 | 0.05 |

TABLE 2-2

| | | | | | Boiling |
|---|---|---|---|---|---|
| | | | | Molecular | point |
| | | | SP value | weight | (degrees |
| Component | | Medicine | (cal/cm³)^{0.5} | (g/mol) | Celsius) |
| Solvent | Organic | 1,2-propane | 15.91 | 76.09 | 188.2 |
| | solvent | diol | | | |
| | other than | 3-methoxy- | 10.92 | 118.176 | 174 |
| | glycolether | 3-methyl-1- | | | |
| | | butanol | | | |
| | | 2,3- | 14.60 | 90.121 | 177 |
| | | butanediol | | | |
| | | 2-ethyl-1,3- | 11.72 | 146.2 | 244 |
| | | hexanediol | | | |
| | | 3-methoxy- | 9.19 | 131.17 | 215 |
| | | N,N- | | | |
| | | dimethyl | | | |
| | | propanamide | | | |
| | | 1,2-hexane | 12.59 | 118.17 | 170 |
| | | diol | | | |
| | Glycol | Propylene | 10.19 | 90.13 | 121 |
| | ether | glycol | | | |
| | | monomethyl | | | |
| | | ether | | | |
| | | Diethylene | 10.7 | 162.23 | 231 |
| | | glycol | | | |
| | | monobutyl | | | |
| | | ether | | | |
| | | Triethylene | 13.58 | 150.18 | 287 |
| | | glycol | | | |
| | | Glycerin | 20.02 | 92.09 | 290 |
| | | Diethylene | 14.97 | 106.12 | 244 |
| | | glycol | | | |

Mixed SP value (cal/cm³)^{0.5} (=SP value of organic solvent A ×
molar fraction of organic solvent A) + . . .

| Surfactant | TRITON |
|---|---|
| | HW-1000 |
| | WET-270 |
| | SAG503A |
| Antibacterial agent | PROXEL LV |
| Defoaming agent | AD01 |
| Water | Highly pure |
| | water |
| aggregating agent | Magnesium |
| | acetate |
| | Aluminum |
| | nitrate |
| | Magnesium |
| | nitrate |
| | Magnesium |
| | sulfate |
| | Citric acid |
| | Acetic acid |
| | Polyethylene |
| | imine |
| pH regulator | AEPD |
| pH buffering agent | CHES |

Pre-processing fluid

| 9 | 10 | 11 | 12 | 13 | 14 | 15 | 16 |
|---|---|---|---|---|---|---|---|
| 18.0 | 18.0 | 10.0 | 20.0 | 10.0 | 20.0 | 18.0 | 18.0 |
| 15.0 | 15.0 | 10.0 | 15.0 | 10.0 | 15.0 | 15.0 | 15.0 |
| 5.0 | 5.0 | 5.0 | 5.0 | 3.0 | 5.0 | 5.0 | 5.0 |
| 3.0 | 3.0 | 20.0 | | 20.0 | | 3.0 | 3.0 |
| | | | 2.0 | | 3.0 | | |
| 14.11 | 14.11 | 13.29 | 14.59 | 13.22 | 14.71 | 14.11 | 14.11 |
| 2.0 | 2.0 | 2.0 | 2.0 | 2.0 | 2.0 | 2.0 | 2.0 |
| 3.0 | 3.0 | 3.0 | 3.0 | 3.0 | 3.0 | 3.0 | 3.0 |
| 0.1 | 0.1 | 0.1 | 0.1 | 0.1 | 0.1 | 0.1 | 0.1 |
| 1.0 | 1.0 | 1.0 | 1.0 | 1.0 | 1.0 | 1.0 | 1.0 |
| 32.6 | 32.6 | 38.6 | 41.6 | 40.6 | 40.6 | 51.7 | 31.6 |
| | | 10.0 | 10.0 | 10.0 | 10.0 | 0.9 | 21.0 |
| 20.0 | | | | | | | |
| | 20.0 | | | | | | |
| 0.25 | 0.25 | 0.25 | 0.25 | 0.25 | 0.25 | 0.25 | 0.25 |
| 0.05 | 0.05 | 0.05 | 0.05 | 0.05 | 0.05 | 0.05 | 0.05 |

An ink set was prepared by combining Pre-processing Fluid 1 with Color Ink 1 as shown in Table 3-1, and images were formed as follows.

Pre-processing Fluid 1 and Color Ink 1 were loaded into an inkjet printer (model: IPSiO GXe5500 modified model, available from Ricoh Co., Ltd.), and a halftone image with a print rate of 10 to 90 percent at 600 dpi×600 dpi resolution was printed at a droplet volume of 21 μL of Pre-processing Fluid 1 per drop onto offset coated paper (OK Top Coat+(basis weight: 127.9 g/m²), available from Oji Paper Co., Ltd.). The printed sheet was then dried and fixed by passage of a hot air drying unit at 80 degrees Celsius.

Next, Color Ink 1 was printed onto the offset coated paper where Pre-processing Fluid 1 had been applied. A solid color image at 100 percent tone was printed at 600 dpi×600 dpi resolution with a droplet volume of 21 pL per drop of Color Ink 1, followed by drying and fixing by passage of a hot air drying unit at 80 degrees Celsius to obtain the printed material of Example 1.

Subsequently, the ink in Example 1 was evaluated for Contact Angle of Color Ink on Pre-processing Fluid, Beading, Bleeding, Pinning Speed, and Discharging Stability using the methods described below. The results are shown in Table 3-1.

### Examples 2 to 35 and Comparative Examples 1 to 15

The printed materials of each of Examples 2 to 35 and Comparative Examples 1 to 15 were obtained in the same manner as in Example 1 except that the combination of Color Ink 1 and Pre-processing Fluid 1 was changed to those shown in Tables 3-1 and 3-2. These printed materials were then evaluated for Contact Angle of Color Ink on Pre-processing Fluid, Beading, Bleeding, Pinning Speed, and Discharging Stability in the same manner as Example 1. The results are shown in Tables 3-1 to 3-2.

### Method for Determining Contact Angle θ1 of Color Ink

The method of determining the contact angle θ1 of color ink on offset coated paper is described in detail below.

Droplets of the color ink were applied to the surface of the offset coated paper, and the contact angle measured was the value at 1,000 ms after droplet application.

The contact angle meter used to measure the contact angle was Dmo-501, available from Kyowa Interface Science Co., LTD.

This contact angle meter can measure the contact angle of the color ink by placing a droplet of the test sample (color ink) on the surface of offset coated paper and analyzing the image of the droplet.

Measurements were performed in an environment at 25 degrees Celsius. The droplet was formed at the syringe needle tip with an ink drop size adjusted to 3.0 μL. The sample stage holding the offset coated paper was carefully raised to place the droplet on the paper surface. An image was taken 500 ms after application, and the contact angle was determined using the θ/2 method with the analysis software “FAMAS (interFAce Measurement & Analysis System)” installed in the device. Each measurement was repeated three times, and the average value was determined as the contact angle for the sample.

### Method of Determining Contact Angle θ2 of Color Ink on Pre-processing Fluid Coated Surface

The method of determining the contact angle θ2 of the ink on the pre-processing fluid coated surface is described in detail below. After applying the pre-processing fluid on the offset coated paper using a bar coater to achieve a coating weight of 9.0 g/m², the coated paper was dried in a dryer at 80 degrees Celsius. The ink was then applied to this coating, and the contact angle was measured at 500 ms after application.

### Beading

The “Glossy Paper—Fine” mode on the printer driver was modified to “No Color Correction” mode, and a solid image was printed to visually inspect density unevenness (beading) in the solid image. The evaluation criteria are as follows:

### Evaluation Criteria

A: None at all
B: Slightly present
C: Considerably present
D: Severely present

Since the black solid image was very difficult for visual confirmation, it was observed by an optical microscope at 40× magnification.

### Bleeding

The Glossy Paper—Fine mode on the printer driver was modified to No Color Correction mode, and a solid image was created by mixing black ink and color ink on offset coated paper. The boundary area of the mixed solid image was visually inspected for Color Boundary Bleeding according to the following criteria. A rating of C or above is considered acceptable for practical use.

### Evaluation Criteria

A: No noticeable bleeding at the boundary; high-quality image
B: Slight bleeding at the boundary; acceptable image quality
C: Some bleeding at the boundary; image is usable
D: Significant bleeding at the boundary; low-quality image

### Pinning Speed

The pre-processing fluid was applied to offset coated paper with a bar coater at a coating weight of 9.0 g/m², dried at 80 degrees Celsius, and then the color ink was applied with a bar coater at a coating weight of 9.0 g/m². The dry and film-forming state of the sample was monitored in real-time by irradiating the coating with a laser and analyzing the interference pattern of scattered reflected light using the CurinScan Classic (available from SANYO TRADING CO., LTD.). The time from application of Color Inks 1 to 41 with the bar coater until the intensity of scattered reflected light stabilized was considered the pinning time.

### Evaluation Criteria

A: Time until color ink pinning≤10 seconds
B: 10 seconds<Time until color ink pinning≤20 seconds
C: 20 seconds<Time until color ink pinning≤30 seconds
D: 30 seconds<Time until color ink pinning≤60 seconds

### Discharging Stability

Each ink was loaded into an inkjet discharging device (available from Ricoh Co., Ltd.) equipped with an inkjet head GEN5 (available from Ricoh Printing Systems Co., Ltd.), and the discharging condition of the nozzles was observed with a camera (ARTCAM-036MI, available from Artray Co., Ltd.) after continuous discharging for 30 minutes. Evaluation criteria are as follows.

### Evaluation Criteria

A: Discharged from all nozzles
B: Fewer than 10 nozzles with discharging failure observed
C: 10 to 29 nozzles with discharging failure observed
D: 30 or more nozzles with discharging failure observed

TABLE 3-1

| | | Example | | | | | |
|---|---|---|---|---|---|---|---|
| | | 1 | 2 | 3 | 4 | 5 | 6 |
| Pre-processing fluid | | Pre- | Pre- | Pre- | Pre- | Pre- | Pre- |
| No. | | processing | processing | processing | processing | processing | processing |
| | | fluid 1 | fluid 1 | fluid 1 | fluid 1 | fluid 2 | fluid 3 |
| Ink No. | | Color Ink 1 | Color Ink 2 | Color Ink 3 | Color Ink 4 | Color Ink 1 | Color Ink 1 |
| Quality | Beading | A | A | A | A | A | A |
| | Bleeding | A | A | A | A | A | A |
| | Pinning | A | A | A | A | A | A |
| | speed | | | | | | |
| | Discharging | A | A | A | A | A | A |
| | stability | | | | | | |
| Contact angle ° of | | 25.0 | 24.0 | 23.0 | 23.0 | 25.0 | 25.0 |
| color ink to pre- | | | | | | | |
| processing fluid | | | | | | | |
| (θ1 − θ2) | | | | | | | |
| | | Example | | | | | |
| | | 7 | 8 | 9 | 10 | 11 | 12 |
| Pre-processing fluid | | Pre- | Pre- | Pre- | Pre- | Pre- | Pre- |
| No. | | processing | processing | processing | processing | processing | processing |
| | | fluid 3 | fluid 4 | fluid 5 | fluid 6 | fluid 7 | fluid 8 |
| Ink No. | | Color Ink 1 | Color Ink 5 | Color Ink 6 | Color Ink 7 | Color Ink 8 | Color Ink 9 |
| Quality | Beading | A | A | A | A | A | |
| | Bleeding | A | A | A | A | A | |
| | Pinning | A | A | A | A | A | |
| | speed | | | | | | |
| | Discharging | A | A | A | A | A | |
| | stability | | | | | | |
| Contact angle ° of | | 25.0 | 27.0 | 22.0 | 27.0 | 25.0 | 25.0 |
| color ink to pre- | | | | | | | |
| processing fluid | | | | | | | |
| (θ1 − θ2) | | | | | | | |
| | | Example | | | | | |
| | | 13 | 14 | 15 | 16 | 17 | 18 |
| Pre-processing fluid | | Pre- | Pre- | Pre- | Pre- | Pre- | Pre- |
| No. | | processing | processing | processing | processing | processing | processing |
| | | fluid 9 | fluid 1 | fluid 1 | fluid 1 | fluid 10 | fluid 11 |
| Ink No. | | Color Ink 10 | Color Ink 11 | Color Ink 12 | Color Ink 13 | Color Ink 14 | Color Ink 5 |
| Quality | Beading | A | A | A | A | A | A |
| | Bleeding | A | A | A | A | A | A |
| | Pinning | A | A | A | A | A | A |
| | speed | | | | | | |
| | Discharging | A | A | A | A | A | A |
| | stability | | | | | | |
| Contact angle ° of | | 25.0 | 25.0 | 25.0 | 27.0 | 29.0 | 27.0 |
| color ink to pre- | | | | | | | |
| processing fluid | | | | | | | |
| (θ1 − θ2) | | | | | | | |
| | | Example | | | | | |
| | | 19 | 20 | 21 | 22 | 23 | 24 |
| Pre-processing fluid | | Pre- | Pre- | Pre- | Pre- | Pre- | Pre- |
| No. | | processing | processing | processing | processing | processing | processing |
| | | fluid 12 | fluid 1 | fluid 1 | fluid 1 | fluid 1 | fluid 1 |
| Ink No. | | Color Ink 1 | Color Ink 16 | Color Ink 16 | Color Ink 17 | Color Ink 18 | Color Ink 19 |
| Quality | Beading | A | B | A | A | A | A |
| | Bleeding | A | B | A | A | A | A |
| | Pinning | A | B | A | B | C | B |
| | speed | | | | | | |
| | Discharging | A | B | A | A | A | A |
| | stability | | | | | | |
| Contact angle ° of | | 25.0 | 25.0 | 25.0 | 24.0 | 24.0 | 22.0 |
| color ink to pre- | | | | | | | |
| processing fluid | | | | | | | |
| (θ1 − θ2) | | | | | | | |
| | | Example | | | | | |
| | | 25 | 26 | 27 | 28 | 29 | 30 |
| Pre-processing fluid | | Pre- | Pre- | Pre- | Pre- | Pre- | Pre- |
| No. | | processing | processing | processing | processing | processing | processing |
| | | fluid 1 | fluid 1 | fluid 1 | fluid 1 | fluid 1 | fluid 1 |
| Ink No. | | Color Ink 20 | Color Ink 21 | Color Ink 22 | Color Ink 23 | Color Ink 24 | Color Ink 25 |
| Quality | Beading | A | B | B | C | A | A |
| | Bleeding | A | A | B | C | A | B |
| | Pinning | B | A | C | C | A | B |
| | speed | | | | | | |
| | Discharging | A | A | A | B | C | A |
| | stability | | | | | | |

| | | | | | | |
|---|---|---|---|---|---|---|
| Contact angle ° of | 23.0 | 21.0 | 29.0 | 25.0 | 20.0 | 25.0 |
| color ink to pre- | | | | | | |
| processing fluid | | | | | | |
| (θ1 − θ2) | | | | | | |

| | | Example | | | | |
|---|---|---|---|---|---|---|
| | | 31 | 32 | 33 | 34 | 35 |
| Pre-processing fluid | | Pre- | Pre- | Pre- | Pre- | Pre- |
| No. | | processing | processing | processing | processing | processing |
| | | fluid 1 | fluid 13 | fluid 14 | fluid 1 | fluid 1 |
| Ink No. | | Color Ink 26 | Color Ink 1 | Color Ink 1 | Color Ink 27 | Color Ink 28 |
| Quality | Beading | A | B | B | B | B |
| | Bleeding | B | B | A | B | A |
| | Pinning | B | B | A | C | A |
| | speed | | | | | |
| | Discharging | A | A | A | A | A |
| | stability | | | | | |

| | | | | | |
|---|---|---|---|---|---|
| Contact angle ° of | 25.0 | 25.0 | 25.0 | 18.0 | 28.0 |
| color ink to pre- | | | | | |
| processing fluid | | | | | |
| (θ1 − θ2) | | | | | |

TABLE 3-2

| | | Comparative Example | | | | | | |
|---|---|---|---|---|---|---|---|---|
| | | 1 | 2 | 3 | 4 | 5 | 6 | 7 |
| Pre-processing fluid | | Pre- | Pre- | Pre- | Pre- | Pre- | Pre- | Pre- |
| No. | | processing | processing | processing | processing | processing | processing | processing |
| | | fluid 1 | fluid 1 | fluid 1 | fluid 1 | fluid 1 | fluid 1 | fluid 1 |
| Ink No. | | Color Ink 29 | Color Ink 30 | Color Ink 31 | Color Ink 32 | Color Ink 33 | Color Ink 34 | Color Ink 35 |
| Quality | Beading | C | C | D | D | B | D | D |
| | Bleeding | D | D | D | B | D | A | A |
| | Pinning | D | D | D | D | D | C | A |
| | speed | | | | | | | |
| | Discharging | A | C | B | D | B | C | A |
| | stability | | | | | | | |

| | | | | | | | |
|---|---|---|---|---|---|---|---|
| Contact angle ° of | 18.0 | 18.0 | 18.0 | 18.0 | 18.0 | 22.0 | 27.0 |
| color ink to pre- | | | | | | | |
| processing fluid | | | | | | | |
| (θ1 − θ2) | | | | | | | |

| | | Comparative Example | | | | | | | |
|---|---|---|---|---|---|---|---|---|---|
| | | 8 | 9 | 10 | 11 | 12 | 13 | 14 | 15 |
| Pre-processing fluid | | Pre- | Pre- | Pre- | Pre- | Pre- | Pre- | Pre- | Pre- |
| No. | | processing | processing | processing | processing | processing | processing | processing | processing |
| | | fluid 1 | fluid 1 | fluid 15 | fluid 16 | fluid 1 | fluid 1 | fluid 1 | fluid 1 |
| Ink No. | | Color Ink 36 | Color Ink 37 | Color Ink 1 | Color Ink 1 | Color Ink 38 | Color Ink 39 | Color Ink 40 | Color Ink 41 |
| Quality | Beading | D | D | D | D | D | A | C | C |
| | Bleeding | D | A | D | A | D | A | C | C |
| | Pinning | D | A | D | A | D | A | D | D |
| | speed | | | | | | | | |
| | Discharging | A | A | A | D | A | D | A | A |
| | stability | | | | | | | | |

| | | | | | | | | |
|---|---|---|---|---|---|---|---|---|
| Contact angle ° of | 18.0 | 25.0 | 18.0 | 25.0 | 18.0 | 29.0 | 18.0 | 18.0 |
| color ink to pre- | | | | | | | | |
| processing fluid | | | | | | | | |
| (θ1 − θ2) | | | | | | | | |

The aspects of the present disclosure are, for example, as follows:

### Aspect 1

An ink set contains a pre-processing fluid containing water, an aggregating agent, and a first organic solvent, a pigment ink containing a second organic solvent containing water, a coloring material, and a glycolether compound, a polyoxyethylene alkyl ether, and a resin, wherein the content of the aggregating agent in the pre-processing fluid is between 1.0 percent by mass and 20.0 percent by mass, the content of the glycolether compound in the pigment ink is between 10.0 percent by mass and 20.0 percent by mass, the content of the polyoxyethylene alkyl ether in the pigment ink is between 1.0 percent by mass and 5.0 percent by mass, and the following Relationship is satisfied: 0.25≤P/R≤3.0, where P represents the content of the coloring material in the pigment ink and R represents the content of the resin in the pigment ink, and the difference in the mixed SP value between the first organic solvent and the second organic solvent is at least 2.0 (cal/cm³)^{0.5}.

### Aspect 2

The ink set according to Aspect 1 mentioned above, wherein the polyoxyethylene alkyl ether is a compound represented by the following Chemical Formula 1,

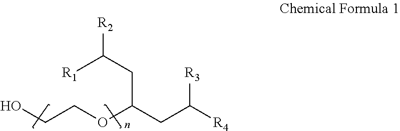

In Chemical Formula 1, R₁, R₂, R₃, and R₄ each, independently, represent hydrogen atoms or alkyl groups having 1 to 5 carbon atoms, and n represents an integer of from 4 to 10.

### Aspect 3

The ink set according to Aspect 1 or 2 mentioned above, wherein the glycolether compound comprises a glycol ether compound having at least 8 carbon atoms.

### Aspect 4

The ink set according to any one of Aspects 1 to 3 mentioned above, wherein the first organic solvent and the second organic solvent each are alcohol-based solvents with a boiling point of at most 250 degrees Celsius.

### Aspect 5

The ink set according to any one of Aspects 1 to 4 mentioned above, wherein the first organic solvent has a mixed SP value between 13.0 (cal/cm³)^{0.5} and 15.0 (cal/cm³)^{0.5} and the second organic solvent has an mixed SP value between 10.0 (cal/cm³)^{0.5} and 12.0 (cal/cm³)^{0.5}.

### Aspect 6

The ink set according to any one of Aspects 1 to 5 mentioned above, wherein the content of the second organic solvent is between 20.0 percent by mass and 40.0 percent by mass.

### Aspect 7

The ink set according to any one of Aspects 1 to 6 mentioned above, wherein the resin contains a resin having a glass transition temperature Tg of at least 30 degrees Celsius.

### Aspect 8

The ink set according to Aspect mentioned above, wherein the resin contains a resin having a glass transition temperature Tg lower than 0 degrees Celsius.

### Aspect 9

The ink set according to claim 1, satisfying the following Relationship A, 20°<θ1−θ2<30° Relationship A where θ1 represents a contact angle of the pigment ink to a printing medium where the pre-processing fluid is applied, and θ2 represents a contact angle of the pigment ink to a printing medium where the pre-processing fluid is not applied.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An ink set comprising:
a pre-processing fluid comprising
water;
an aggregating agent; and
a first organic solvent;
a pigment ink comprising:
a second organic solvent comprising:
water;
a coloring material; and
a glycolether compound;
a polyoxyethylene alkyl ether; and
a resin,
wherein a content of the aggregating agent in the pre-processing fluid is between 1.0 percent by mass and 20.0 percent by mass,
a content of the glycolether compound in the pigment ink is between 10.0 percent by mass and 20.0 percent by mass,
a content of the polyoxyethylene alkyl ether in the pigment ink is between 1.0 percent by mass and 5.0 percent by mass,
the following Relationship is satisfied: 0.25≤P/R≤3.0
where P represents a content of the coloring material in the pigment ink, and
R represents a content of the resin in the pigment ink, and
a difference in a mixed SP value between the first organic solvent and the second organic solvent is at least 2.0 (cal/cm³)^{0.5}.

2. The ink set according to claim 1,
wherein the polyoxyethylene alkyl ether is a compound represented by the following Chemical Formula 1, 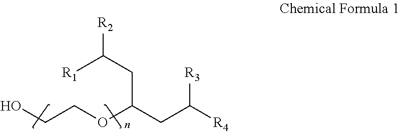
where R₁, R₂, R₃, and R₄ each, independently, represent hydrogen atoms or alkyl groups having 1 to 5 carbon atoms, and n represents an integer of from 4 to 10.

3. The ink set according to claim 1,
wherein the glycolether compound comprises a glycol ether compound having at least 8 carbon atoms.

4. The ink set according to claim 1,
wherein the first organic solvent and the second organic solvent each are alcohol-based solvents with a boiling point of at most 250 degrees Celsius.

5. The ink set according to claim 1,
wherein the first organic solvent has a mixed SP value between 13.0 (cal/cm³)^{0.5} and 15.0 (cal/cm³)^{0.5} and the second organic solvent has a mixed SP value between 10.0 (cal/cm³)^{0.5} and 12.0 (cal/cm³)^{0.5}.

6. The ink set according to claim 1,
wherein a content of the second organic solvent is between 20.0 percent by mass and 40.0 percent by mass.

7. The ink set according to claim 1,
wherein the resin comprises a resin having a glass transition temperature Tg of at least 30 degrees Celsius.

8. The ink set according to claim 7,
wherein the resin comprises a resin having a glass transition temperature Tg of lower than 0 degrees Celsius.

9. The ink set according to claim 1, satisfying the following Relationship A,
$$20 ° < θ 1 - θ 2 < 30 ° \qquad Relationship A$$
where θ1 represents a contact angle of the pigment ink to a recording medium where the pre-processing fluid is applied, and θ2 represents a contact angle of the pigment ink to a recording medium where the pre-processing fluid is not applied.
